(19) United States
(12) Patent Application Publication
(10) Pub. No.: US 2025/0055819 A1
(43) Pub. Date: Feb. 13, 2025

(54) INTELLIGENT MESSAGE SHARING ACROSS RELATED DEVICES

(71) Applicant: International Business Machines Corporation, Armonk, NY (US)

(72) Inventors: Hui Wang, Beijing (CN); Xiao Chen Huang, Beijing (CN); Xiang Yu Xue, Beijing (CN); Yu Mei Dai, Beijing (CN); Mai Zeng, Beijing (CN); Wei Li, Beijing (CN)

(73) Assignee: International Business Machines Corporation, Armonk, NY (US)

(21) Appl. No.: 18/230,986

(22) Filed: Aug. 7, 2023

(51) Int. Cl. H04L 51/046; H04L 51/21

(52) U.S. Cl. CPC H04L 51/046; H04L 51/21

(57) ABSTRACT

A method for intelligently distributing messages across multiple devices and associated chat applications is disclosed. In one embodiment, such a method includes registering multiple devices and associated chat applications to receive intelligent distribution of messages. The method monitors, using an agent, a message copied from a first device of the multiple devices to a clipboard. The method automatically analyzes content of the message to determine which other devices and associated chat applications of the plurality are eligible to receive the message. The message is then distributed to other devices and associated chat applications that are deemed eligible to receive the message. In certain embodiments, the message originates from a first chat application of a first type and the message is distributed to a second chat application of a second type that is different from the first type. A corresponding system and computer program product are also disclosed.

### BACKGROUND

### Field of the Invention

This invention relates generally to messaging applications, and more particularly to systems and methods for sharing messages across different devices and messaging applications.

### Background of the Invention

Chat applications, also known as messaging applications, have become an integral part of modern communication, revolutionizing the way people interact and stay connected. These software applications allow users to send and receive text-based messages in real-time, facilitating instant communication across the globe. With features like group chats, media sharing, emojis, and voice and video calls, chat applications provide a versatile platform for both personal and professional use. Whether catching up with friends and family, collaborating with colleagues, or conducting business meetings, chat applications offer a seamless and efficient means of exchanging information and staying in touch.

In addition to text-based messaging, many chat applications now prioritize user privacy and security through end-to-end encryption, ensuring that only the sender and recipient can access the messages. This focus on safeguarding user data has contributed to their widespread adoption. Furthermore, the continuous development and innovation in chat application technology have led to the integration of additional services, such as payment systems, chatbots, and cloud storage, making these applications even more versatile and indispensable in various aspects of daily life. As chat applications continue to evolve and adapt to user needs, they are likely to remain a central communication tool, shaping the way individuals and entities interact and connect with one another in the digital age.

### SUMMARY

The invention has been developed in response to the present state of the art and, in particular, in response to the problems and needs in the art that have not yet been fully solved by currently available systems and methods. Accordingly, systems and methods have been developed for intelligently distributing messages across a plurality of devices and associated chat applications. The features and advantages of the invention will become more fully apparent from the following description and appended claims, or may be learned by practice of the invention as set forth hereinafter.

Consistent with the foregoing, a method for intelligently distributing messages across multiple devices and associated chat applications is disclosed. In one embodiment, such a method includes registering multiple devices and associated chat applications to receive intelligent distribution of messages. The method monitors, using an agent, a message copied from a first device of the multiple devices to a clipboard. The method automatically analyzes content of the message to determine which other devices and associated chat applications of the plurality are eligible to receive the message. The message is then distributed to other devices and associated chat applications that are deemed eligible to receive the message. In certain embodiments, the message originates from a first chat application of a first type and the message is distributed to a second chat application of a second type that is different from the first type.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing an architecture of a message sharing system in accordance with the invention;

FIG. 3 is an example of a device list used by the registration module;

FIG. 4 is an example of a distribution list used by the distribution module;

FIG. 5 is a high-level block diagram showing functionality of the monitoring module;

FIG. 6 is a process flow diagram showing how a chat service may be used to obtain a match between a chat record and clipboard content; and

FIG. 7 is a high level block diagram showing an exemplary process flow for the message sharing system.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., a “message sharing module 150”) for sharing messages across related devices. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

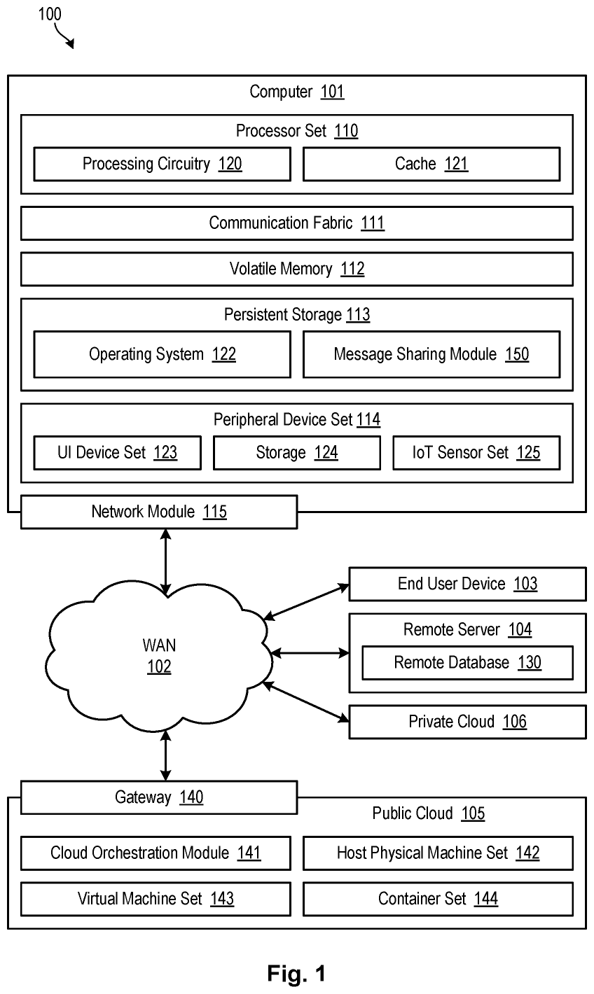

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

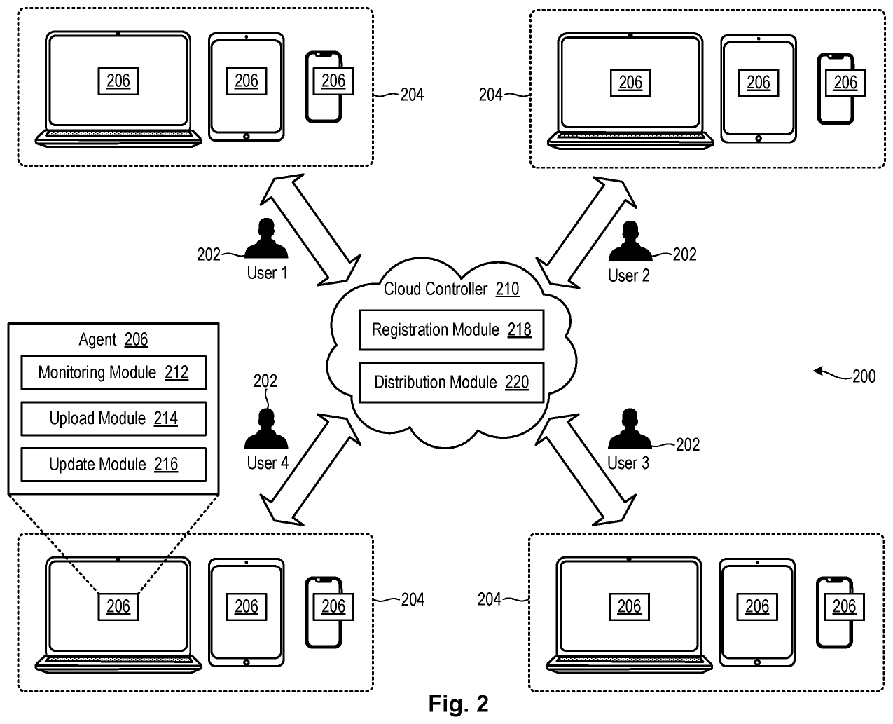

Referring to FIG. 2, as previously mentioned, chat applications have become an integral part of modern communication, revolutionizing the way people interact with one another and stay connected. These software applications enable users to send and receive text-based messages in real-time, facilitating instant communication across virtually all parts of the globe. With features like group chats, media sharing, emojis, and voice and video calls, chat applications provide a versatile platform for both personal and professional use. Chat applications offer a seamless and efficient means of exchanging information and staying in touch in scenarios such as catching up with friends and family, collaborating with colleagues, and conducting business meetings.

Nevertheless, the number and variety of chat applications has grown dramatically. Furthermore, the number of devices (e.g., desktop computers, laptop computers, smart phones, tablets, etc.) a user may have and utilize on a regular basis has also grown dramatically. Providing the ability to use each chat application on each device may require installing and configuring the chat applications on each device. This can become cumbersome and unwieldly as well as undesirably consume storage on each device. Further complicating the situation is that each chat application typically works in isolation and does not have the ability to communicate with chat applications of other types. Thus, the user may have no choice other than to install and configure each chat application on each of the user's devices assuming the user wants the ability to communicate on each device. Thus, any system or method that can facilitate communication between chat applications without requiring each chat application to be installed on each device would be an advance in the art. One such system 200 is illustrated in FIG. 2,

FIG. 2 is a high-level block diagram showing an architecture of one embodiment of a system 200 for sharing messages across related devices without requiring the same chat applications to be installed across the devices. In general, each device may have a clipboard that acts as a temporary storage space in the device's memory and that enables copying and pasting of data between applications or within the same application. As will be explained in more detail hereafter, the message sharing system 200 may leverage this functionality to enable message sharing across devices as well as across chat applications, even different chat applications, on the devices. This reduces or eliminates the need to install the same chat applications across all of a user's devices.

FIG. 2 shows a plurality of users 202 (i.e., Users 1-4), each with their own set of devices 204, which may include desktop computers, laptop computers, smart phones, tablets, etc. Each of these devices 204 may contain clipboard functionality. In order to facilitate message sharing between these devices 204, and between chat applications installed on each of these devices 204, an agent 206 in accordance with the invention may installed on each of the devices 204. These agents 206 may manage each user's clipboard and trigger message sharing across the devices 204 and more specifically between chat applications installed on the devices 204.

As will be explained in more detail hereafter, when a message is generated or received by a chat application on a device 204, the message may be detected and copied to the device's clipboard. This message may then be distributed to other devices 204 and chat applications, including devices 204 and chat applications associated with the user that originated the message as well as potentially devices 204 and chat applications of other users. This may enable message sharing across chat applications, such that a message from a chat application of a first type (e.g., WhatsApp, Facebook Messenger, Telegram, WeChat, Slack, Discord, Line, Viber, Signal, etc.) may be shared with a chat application of a second type that is different from the first type. For example, a WhatApp message from the WhatsApp chat application 504 on a first device may potentially be shared with a Slack chat application 504 on another device 204.

In order to provide the above-described functionality, various modules may be provided. For example, each agent 206 may include one or more of a monitoring module 212, upload module 214, and update module 216. A cloud controller 210 may include one or more of a registration module 218 and distribution module 220. These modules may be implemented in hardware, software, firmware, or combinations thereof. The modules are presented by way of example and not limitation. More or fewer modules may be provided in different embodiments. For example, the functionality of some modules may be combined into a single or smaller number of modules, or the functionality of a single module may be distributed across several modules. Although the modules and associated functionality are shown in certain locations or within certain components they are not necessarily located in the illustrated places or components. Thus, the location of the modules is also provided by way of example and not limitation.

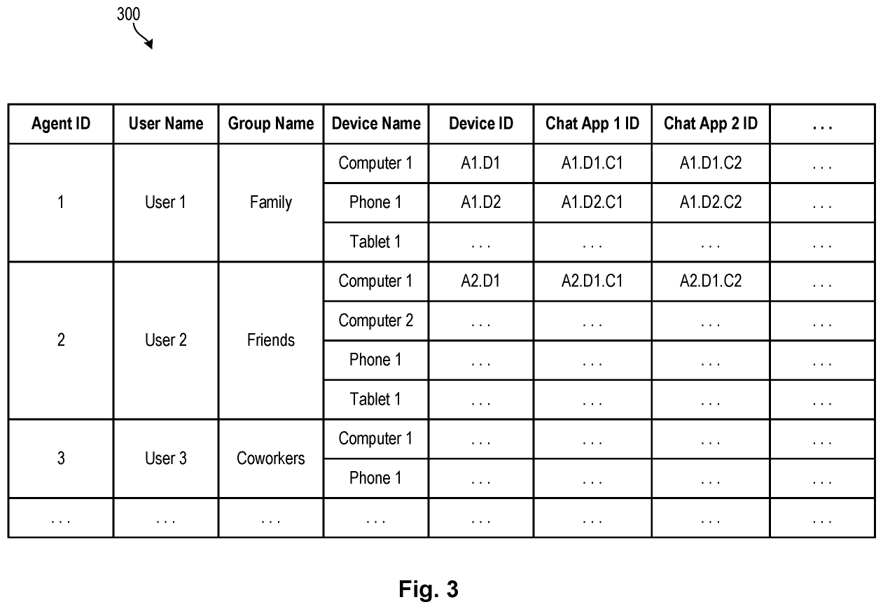

The registration module 218 may be configured to register users 202, devices 204, and chat applications that are configured to participate in the disclosed message sharing. A user may register the user's devices 204 and chat applications by way of the cloud controller 210. FIG. 3 shows one example of a device list 300 that may be maintained by the registration module 218. As shown, the device list 300 may store one or more of an agent identifier for each user 202, a user name, a group name, device names associated with each device 204 of a user 202, device identifiers (e.g., A1.D1, A1.D2, A2.D1, etc.), and chat application identifiers (e.g., A1.D1.C1, A1.D2.C1, A2.D1.C1, etc.). In certain embodiments, the registration module 218 synchronizes the device list 300 across all agents 206 in the message sharing system 200.

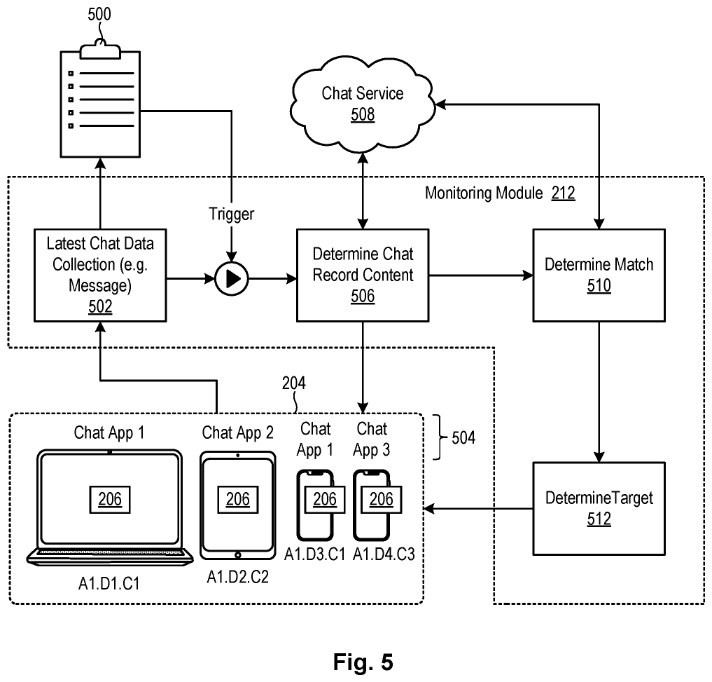

The monitoring module 212 of each agent 206 may monitor the universal clipboard for the associated device 204. When an update of the clipboard is detected (i.e., the clipboard is updated with a message from a chat application on the device 204), the monitoring module 212 may trigger various actions to determine which devices 204 and associated chat applications are eligible to receive the clipboard contents. These actions will be described in more detail in association with FIG. 5.

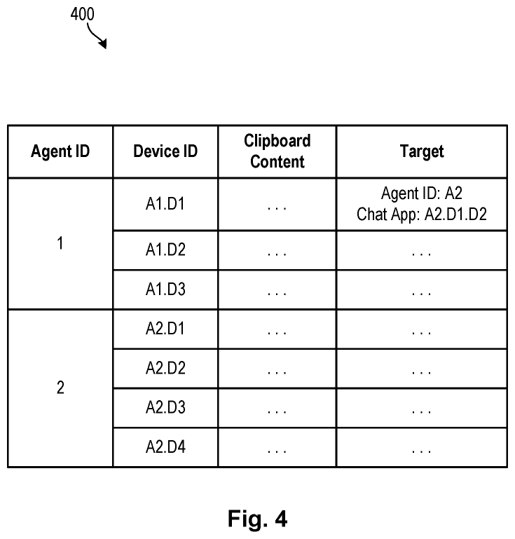

Once the monitoring module 212 makes this determination, the monitoring module 212 may send a list of the eligible devices 204 to the upload module 214. The upload module 214 may, in turn, upload the clipboard contents and the list of eligible devices to the distribution module 220 on the cloud controller 210. This will enable the distribution module 220 to forward the clipboard contents to the eligible devices 204 in the message sharing system 200. FIG. 4 shows one example of a list 400 of eligible devices 204 and associated clipboard content that may be sent to the distribution module 220 for distribution to the eligible devices 204.

Once clipboard content has been received by an agent 206 from the distribution module 220, the update module 216 within the agent 206 may update the clipboard of the associated device 204 with the received content. This may allow the content to be copied into any of the chat applications of the associated device 204. This may occur either manually or automatically.

Referring to FIG. 5, as previously mentioned, when an update of the clipboard 500 is detected (i.e., the clipboard 500 is updated with a message 502 from a chat application 504 on a device 204), the monitoring module 212 may trigger various actions to determine which devices 204 and associated chat applications 504 are eligible to receive the clipboard contents. For example, when a new message 502 is received to the clipboard 500, the monitoring module 212 may determine 506 a chat record for devices 204 and chat applications 504 participating in the message sharing system 200 to determine if the new message 502 that has been received to the clipboard 500 is related to the chat record of other devices 204 and chat applications 504.

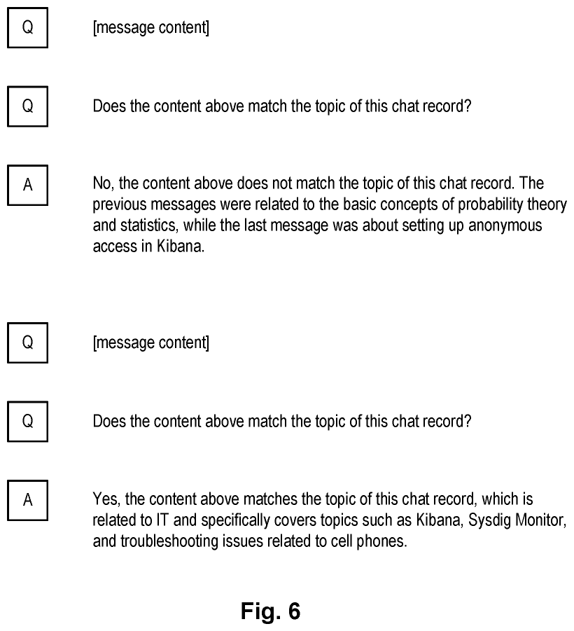

In certain embodiments, this may be accomplished using a chat service 508 (e.g., ChatGPT) or other conversational AI language model as shown in FIG. 6. As shown in FIG. 6, (with “Q” indicating a question by the monitoring module 212 and “A” indicating an answer by the chat service 508), the monitoring module 212 may ask the chat service 508 whether the content in the new message 502 matches the topic of the chat record of the other devices 204. The chat service 508 may, in certain embodiments, respond with either a “Yes” or “No” depending on whether the content of the message 502 is deemed by the chat service 508 to match the topic of the chat record. In certain embodiments, the chat service 508 provides reasoning for its answer as shown in FIG. 6.

Referring again to FIG. 5, using the output of the chat service 508, the monitoring module 212 may determine 510 if there is a match between the content in the new message 502 and the topics of the chat records of the devices 204 participating in the message sharing system 200. If one or more matches are found, the monitoring module 212 may determine 512 the targets (i.e., the devices 204 that are eligible to receive the clipboard content) and send these targets to the upload module 214 along with the content of the message 502.

In certain embodiments, to provide additional data privacy (i.e., not expose clipboard content to a third-party chat service 508), the comparative analysis may be performed on the devices 204 themselves. For example, a device 204 may compare a context vector associated with new clipboard content with a context vector associated with a device's chat record to determine if the new clipboard content matches the topic of the chat record. This may eliminate the need to send the clipboard content or chat records to a third party chat service 508, thus providing additional data privacy.

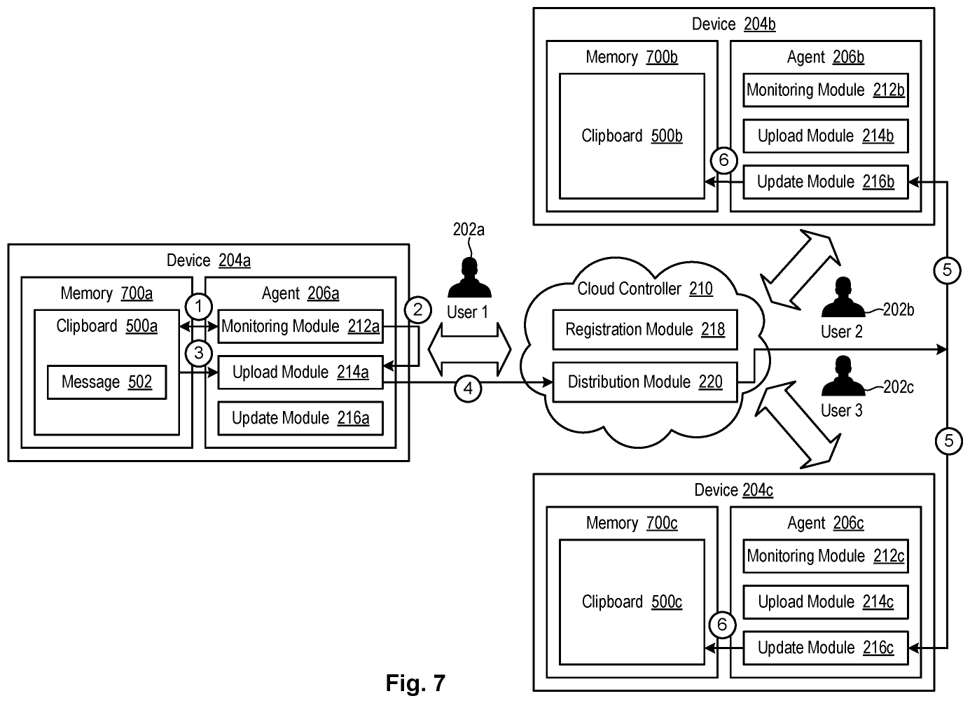

Referring to FIG. 7, a high level block diagram showing an exemplary process flow for the message sharing system 200 is illustrated. The order of steps in the process flow is labelled one through six. As shown, the monitoring module 212a of the agent 206a may monitor the clipboard 500a of the device 204a (i.e., step 1). When an update to the clipboard 500a is detected (i.e., the clipboard 500a is updated with a message 502 from a chat application of the device 204a), the monitoring module 212a may trigger various actions (as were explained in association with FIG. 5) to determine which other devices 204b, 204c and associated chat applications in the message sharing system 200 are eligible to receive the clipboard content 502.

Once the monitoring module 212a makes this determination, the monitoring module 212a may send a list of the eligible devices 204b, 204c to the upload module 214a (i.e., step 2). The upload module 214a may, in turn, upload the clipboard content 502 (i.e., step 3) and the list of eligible devices to the distribution module 220 on the cloud controller 210 (i.e., step 4). This will enable the distribution module 220 to forward the clipboard content 502 to the eligible devices 204b, 204c (i.e., step 5).

Once the clipboard content 502 has been received by the devices 204b, 204c from the distribution module 220, the update modules 216b, 216c of these devices 204b, 204c may update the clipboards 500b, 500c of the associated device 204b, 204c with the content 502. This may allow the content 502 to be copied (i.e., pasted) into any of the chat applications of the devices 204b, 204c.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for intelligently distributing messages across a plurality of devices and associated chat applications, the method comprising:
registering a plurality of devices and associated chat applications to receive intelligent distribution of messages;
monitoring, by an agent, a message copied from a first device of the plurality to a clipboard;
automatically analyzing content of the message to determine which other devices and associated chat applications of the plurality are eligible to receive the message; and
distributing the message to other devices and associated chat applications of the plurality that are deemed eligible to receive the message.

2. The method of claim 1, wherein the message originates from a first chat application of a first type.

3. The method of claim 2, wherein distributing the message comprises distributing the message to a second chat application of a second type that is different from the first type.

4. The method of claim 1, wherein automatically analyzing the content comprises automatically analyzing the content by an artificial intelligence engine.

5. The method of claim 1, wherein automatically analyzing the content comprises automatically analyzing the content to determine which other devices and chat applications are participating in a chat concerning the content.

6. The method of claim 1, wherein automatically analyzing the content comprises automatically analyzing the content to determine a contact to which to distribute the message.

7. The method of claim 1, wherein distributing the message comprises distributing the message by way of a cloud controller.

8. A computer program product for intelligently distributing messages across a plurality of devices and associated chat applications, the computer program product comprising a computer-readable storage medium having computer-usable program code embodied therein, the computer-usable program code configured to perform the following when executed by at least one processor:
register a plurality of devices and associated chat applications to receive intelligent distribution of messages;
monitor, by an agent, a message copied from a first device of the plurality to a clipboard;
automatically analyze content of the message to determine which other devices and associated chat applications of the plurality are eligible to receive the message; and
distribute the message to other devices and associated chat applications of the plurality that are deemed eligible to receive the message.

9. The computer program product of claim 8, wherein the message originates from a first chat application of a first type.

10. The computer program product of claim 9, wherein distributing the message comprises distributing the message to a second chat application of a second type that is different from the first type.

11. The computer program product of claim 8, wherein automatically analyzing the content comprises automatically analyzing the content by an artificial intelligence engine.

12. The computer program product of claim 8, wherein automatically analyzing the content comprises automatically analyzing the content to determine which other devices and chat applications are participating in a chat concerning the content.

13. The computer program product of claim 8, wherein automatically analyzing the content comprises automatically analyzing the content to determine a contact to which to distribute the message.

14. The computer program product of claim 8, wherein distributing the message comprises distributing the message by way of a cloud controller.

15. A system for intelligently distributing messages across a plurality of devices and associated chat applications, the system comprising:
at least one processor;
at least one memory device operably coupled to the at least one processor and storing instructions for execution on the at least one processor, the instructions causing the at least one processor to:
register a plurality of devices and associated chat applications to receive intelligent distribution of messages;
monitor, by an agent, a message copied from a first device of the plurality to a clipboard;
automatically analyze content of the message to determine which other devices and associated chat applications of the plurality are eligible to receive the message; and
distribute the message to other devices and associated chat applications of the plurality that are deemed eligible to receive the message.

16. The system of claim 15, wherein the message originates from a first chat application of a first type.

17. The system of claim 16, wherein distributing the message comprises distributing the message to a second chat application of a second type that is different from the first type.

18. The system of claim 15, wherein automatically analyzing the content comprises automatically analyzing the content by an artificial intelligence engine.

19. The system of claim 15, wherein automatically analyzing the content comprises automatically analyzing the content to determine which other devices and chat applications are participating in a chat concerning the content.

20. The system of claim 15, wherein automatically analyzing the content comprises automatically analyzing the content to determine a contact to which to distribute the message.
